(19) United States
(12) Patent Application Publication
(10) Pub. No.: US 2015/0097655 A1
(43) Pub. Date: Apr. 9, 2015

(54) RADIO FREQUENCY IDENTIFICATION DISPLAY DEVICE

(71) Applicants: Tai-Hwa Liu, Hsinchu City (TW); Yi-Chun Sung, Hsinchu City (TW)

(72) Inventors: Tai-Hwa Liu, Hsinchu City (TW); Yi-Chun Sung, Hsinchu City (TW)

(21) Appl. No.: 14/049,317

(22) Filed: Oct. 9, 2013

(51) Int. Cl. G06K 7/10

(52) U.S. Cl. CPC G06K 7/10366
USPC 340/10.6

(57) ABSTRACT

A radio frequency identification (RFID) display device includes a microprocessor, a first RFID, a second RFID, a sensing module and a passive display unit. The first RFID stores a first RFID data and receives electromagnetic wave emitted from a reader for supply power. The second RFID stores a second RFID data. The first RFID data and the second RFID data are transferred to the microprocessor when the electromagnetic wave is received. The sensing module senses an external environment and generates an environmental sensing signal transferred to the microprocessor. The microprocessor generates a display driving signal to drive the passive display unit based on the received data so as to display the RFID data onto the passive display unit. The microprocessor further adjusts the brightness and the contrast of the passive display unit to achieve better display effect, thereby effectively saving the time of stock take.

### BACKGROUND OF THE INVENTION

1. Field of the Invention

The present invention generally relates to a radio frequency identification (RFID) display device, and more specifically to a RFID display device employing two RFIDs for supplying power and storing data so as to avoid the reading malfunction and improve the safety of the operation.

2. The Prior Arts

With the progress of the technologies in RFID, the current RFIDs can store more data and are broadly used much more than conventional bar code machines, like logistics, storehouse, declaration at customs, electronic purse, and so on.

Owing to the simple architecture of the RFID, usually only comprising the antenna and the RFID chip, the malfunction of reading data possibly occurs when the various goods of the same sort are scanned to read the stored data. Or, it sometimes causes the problem of repeatedly reading data. Additionally, the conventional RFID needs the server and specific management such that the operator can not instantly judge whether the read data is correct. Therefore, it needs a new RFID display device to provide instant display function, thereby overcoming the drawbacks in the prior arts.

### SUMMARY OF THE INVENTION

The primary objective of the present invention is to provide a RFID display device comprises a microprocessor, a first RFID, a second RFID, a sensing module and a passive display unit. The first RFID comprises a first antenna and a first RFID chip connected to the first antenna. The first antenna receives electromagnetic wave emitted from a reader and generates electric energy transferred to the first RFID chip. The first RFID chip is connected to the second RFID, the sensing module and the microprocessor so as to provide the electric energy to the second RFID, the sensing module and the microprocessor. The first RFID chip stores a first RFID data. When the electromagnetic wave from the reader is received, the first RFID data is transferred to the microprocessor and simultaneously transferred to the reader through the first antenna.

The second RFID comprises at least one of a second antenna and a second RFID chip connected to the second antenna. The second antenna is used to receive the electromagnetic wave emitted from the reader, which is further transferred to the second RFID chip. The second RFID chip stores a second RFID data. When the electromagnetic wave from the reader is received, the second RFID data is transferred to the reader through the second antenna and simultaneously transferred to the microprocessor. The sensing module comprises at least one sensor for generating an environmental sensing signal by sensing an external environment such as light, humidity, electrostatic, vibration, pressure, gas, sound. The environmental sensing signal is transferred to the microprocessor.

The microprocessor is connected to the first RFID, the second RFID, the sensing module and the passive display unit. When triggered by the first RFID and receiving the first RFID data, the second RFID data and the environmental sensing signal, the microprocessor generates a display driving signal to drive the passive display unit based on the data and the signal such that the first RFID data and the second RFID data are displayed on the passive display unit. Furthermore, the microprocessor adjusts the brightness and the contrast of the passive display unit according to the environmental sensing signal.

The present invention employs two RFIDs to implement the technology of passively driving the passive display such that no external power is needed. Additionally, the sensing module is used to adjust the brightness and the contrast of the passive display unit to achieve better display effect, thereby effectively saving the time of stock take and improving the efficiency.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing a RFID display device according to one embodiment of the present invention.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

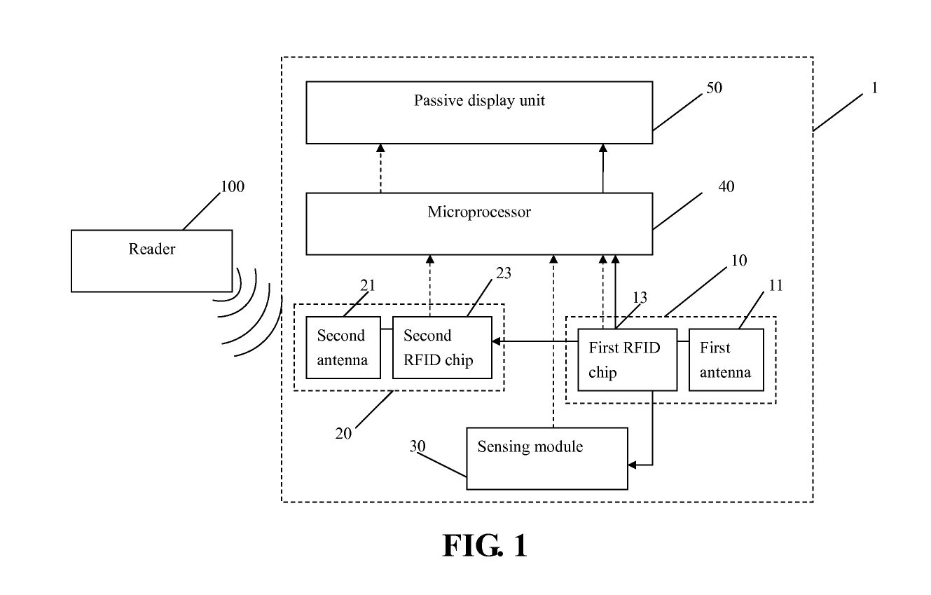

Please refer to FIG. 1, which shows a RFID display device according to one embodiment of the present invention. As shown in FIG. 1, the RFID display device 1 of the present invention comprises a first RFID 10, a second RFID 20, a sensing module 30, a microprocessor 40 and a passive display unit 50. Specifically, the first RFID 10 comprises a first antenna 11 and a first RFID chip 13 connected to the first antenna 11. The first antenna 11 receives electromagnetic wave emitted from a reader 100 and generates electric energy transferred to the first RFID chip 13. The first RFID chip 13 is connected to the second RFID 20, the sensing module 30 and the microprocessor 40 so as to provide the electric energy to the second RFID 20, the sensing module 30 and the microprocessor 40. The first RFID chip 13 stores a first RFID data, and when the electromagnetic wave from the reader 100 is received, the first RFID data is transferred to the microprocessor 40 and simultaneously transferred back to the reader 100 through the first antenna 11.

The second RFID 20 comprises at least one of a second antenna 21 and a second RFID chip 23 connected to the second antenna 21. The second antenna 21 is used to receive the electromagnetic wave emitted from the reader 100, which is further transferred to the second RFID chip 23. The second RFID chip 23 is connected the first RFID chip 13 and driven by the electric power which is provided by the first RFID chip 13. The second RFID chip 23 stores a second RFID data. When the electromagnetic wave from the reader 100 is received, the second RFID data is transferred to the reader 100 through the second antenna 21 and simultaneously transferred to the microprocessor 40. The sensing module 30 is connected to the first RFID chip 13 and driven by the electric power which is provided by the first RFID chip 13. The sensing module 30 comprises at least one sensor for generating an environmental sensing signal by sensing an external environment such as light, humidity, electrostatic, vibration, pressure, gas, sound and the environmental sensing signal is transferred to the microprocessor 40.

The microprocessor 40 is connected to the first RFID 10, the second RFID 20, the sensing module 30 and the passive display unit 50. When triggered by the first RFID 10 and receiving the first RFID data, the second RFID data and the environmental sensing signal, the microprocessor 40 generates a display driving signal to drive the passive display unit 50 based on the data and the signal such that the first RFID data and the second RFID data are displayed on the passive display unit 50. Furthermore, the microprocessor 40 adjusts the brightness and the contrast of the passive display unit 50 according to the environmental sensing signal.

One of the features provided by the present invention is that two RFIDs are used to implement the technology of passively driving the passive display without any external power. Additionally, the sensing module is used to adjust the brightness and the contrast of the passive display unit to achieve better display effect, thereby effectively saving the time of stock take and improving the efficiency.

Although the present invention has been described with reference to the preferred embodiments, it will be understood that the invention is not limited to the details described thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A radio frequency identification (RFID) display device, comprising:
a microprocessor;
a first RFID comprising a first antenna and a first RFID chip connected to the first antenna, the first antenna receiving electromagnetic wave emitted from a reader and generating electric energy transferred to the first RFID chip, the first RFID chip storing a first RFID data for supplying the electric energy;
a second RFID connected to the microprocessor, comprising at least one of a second antenna and a second RFID chip connected to the second antenna, the second antenna receiving the electromagnetic wave emitted from the reader and transferring the electromagnetic wave to the second RFID chip, the second first RFID chip storing a second first RFID data, connected to the first RFID chip, and driven by the electric energy supplied by the first RFID chip;
a sensing module connected to the microprocessor and the first RFID chip, driven by the electric energy supplied by the first RFID chip, and comprising at least one sensor for sensing an external environment to generate an environmental sensing signal transferred to the microprocessor; and
a passive display unit connected to the microprocessor for displaying the first RFID data and the second RFID data,
wherein when the first RFID receives the electromagnetic wave emitted from the reader, the first RFID data is transferred back to the reader through the antenna, and simultaneously transferred to the microprocessor, and when the second RFID receives the electromagnetic wave emitted from the reader, the second RFID data is transferred back to the reader through the antenna, and simultaneously transferred to the microprocessor, such that the microprocessor generates a display driving signal to drive the passive display unit based on the first RFID data, the second RFID data and the environmental sensing signal, and adjusts brightness and contrast performed by the passive display unit according to the environmental sensing signal.

2. The RFID display device as claimed in claim 1, wherein the sensing module senses at least one of light, humidity, electrostatic, vibration, pressure, gas and sound, and generates the sensing signal.

3. The RFID display device as claimed in claim 1, wherein the passive display unit is an electronic paper display device or an OLED (organic light emitting diode) display device.

4. The RFID display device as claimed in claim 1, wherein the first identification data and the second identification data are selected from one of an encryption code and a product data.
